(19) United States
(12) Patent Application Publication
(10) Pub. No.: US 2013/0144467 A1
(43) Pub. Date: Jun. 6, 2013

(54) TRANSPORTATION NETWORK SCHEDULING SYSTEM AND METHOD

(71) Applicants: Joel Kickbusch, Melbourne, FL (US); Jared Cooper, Melbourne, FL (US); Joseph Noffsinger, Grain Valley, MO (US); Ajith Kuttannair Kumar, Erie, PA (US); Mason Samuels, Melbourne, FL (US); Paul Houpt, Niskayuna, NY (US); Mahir Telatar, Melbourne, FL (US); David Eldredge, Melbourne, FL (US); Mitchell Scott Wills, Melbourne, FL (US); Ramu Chandra, Niskayuna, NY (US)

(72) Inventors: Joel Kickbusch, Melbourne, FL (US); Jared Cooper, Melbourne, FL (US); Joseph Noffsinger, Grain Valley, MO (US); Ajith Kuttannair Kumar, Erie, PA (US); Mason Samuels, Melbourne, FL (US); Paul Houpt, Niskayuna, NY (US); Mahir Telatar, Melbourne, FL (US); David Eldredge, Melbourne, FL (US); Mitchell Scott Wills, Melbourne, FL (US); Ramu Chandra, Niskayuna, NY (US)

(21) Appl. No.: 13/311,807

(22) Filed: Dec. 6, 2011

(51) Int. Cl. G08G 9/00

(52) U.S. Cl. 701/2; 701/117

(57) ABSTRACT

A method includes forming a first schedule for a first vehicle to travel in a transportation network. The first schedule includes a first arrival time of the first vehicle at a scheduled location. The method also includes receiving a first trip plan for the first vehicle from an energy management system. The first trip plan is based on the first schedule and designates at least one of tractive efforts or braking efforts to be provided by the first vehicle to reduce at least one of an amount of energy consumed by the first vehicle or an amount of emissions generated by the first vehicle when the first vehicle travels through the transportation network to the scheduled location. The method further includes determining whether to modify the first schedule to avoid interfering with movement of one or more other vehicles by examining the trip plan for the first vehicle.

### CROSS-REFERENCE TO RELATED APPLICATIONS

This application is related to co-pending U.S. patent application Ser. No. ______, which was filed on ______, is titled “Transportation Network Scheduling System And Method,” and is associated with Attorney Docket No. 251396 (552-0044) (referred to herein as the “'______ application”), and U.S. patent application Ser. No. ______, which was filed on ______, is titled “System And Method For Allocating Resources In a Network,” and is associated with Attorney Docket No. 251247 (552-0050). The entire disclosures of the '______ application and the '______ applications are incorporated by reference.

### BACKGROUND

A transportation network for vehicles can include several interconnected main routes on which separate vehicles travel between locations. For example, a transportation network may be formed from interconnected railroad tracks with rail vehicles traveling along the tracks. The vehicles may travel according to schedules that dictate where and when the vehicles are to travel in the transportation network. The schedules may be predetermined in order to arrange for certain vehicles to arrive at various locations in the transportation network at desired times and/or in a desired order.

A network planning algorithm may be used to coordinate the schedules of several vehicles in the transportation network. One goal of the network planning algorithm may be to coordinate the schedules to avoid significant slow downs or congested areas in the flow of movement in the transportation network. For example, the network planning algorithm may seek to arrange the schedules so that the vehicles are able to move to associated destination locations as quickly as possible.

Other algorithms may be used in conjunction with the travel of the vehicles to reduce fuel consumed by the vehicles. For example, a fuel optimization algorithm may be used to determine the speeds at which the vehicles are to travel to a destination location in order to reduce the amount of fuel consumed relative to traveling to the destination location at one or more other speeds. One goal of the fuel optimization algorithm may be to reduce the amount of fuel consumed as much as possible while still allowing the vehicles to reach associated destination locations.

When used together, the network planning algorithm and the fuel optimization algorithm may have competing goals. On one hand, the network planning algorithm may seek to get all vehicles to associated destination locations as quickly as possible, regardless of the amounts of fuel consumed by the vehicles. On the other hand, the fuel optimization algorithm may seek to get the vehicles to the associated destination locations while reducing fuel consumption. The fuel optimization algorithm may cause the vehicles to slow down and, as a result, arrive at the destination locations later than the vehicles could have otherwise arrived.

The goals of the network planning algorithm and the fuel optimization algorithm compete with each other and may result in one or both of the algorithms failing to reach the associated goals. A need exists for coordinating or harmonizing the goals of the different algorithms so that vehicles can travel to destination locations while reducing the amounts of fuel consumed, without significantly slowing the flow of travel of the vehicles in the transportation network.

### BRIEF DESCRIPTION

In one embodiment, a method is provided that includes forming a first schedule for a first vehicle to travel in a transportation network. The first schedule includes a first arrival time of the first vehicle at a scheduled location. The method also includes receiving a first trip plan for the first vehicle from an energy management system. The first trip plan is based on the first schedule and designates at least one of tractive efforts or braking efforts to be provided by the first vehicle to reduce at least one of an amount of energy consumed by the first vehicle or an amount of emissions generated by the first vehicle when the first vehicle travels through the transportation network to the scheduled location. The method further includes determining whether to modify the first schedule to avoid interfering with movement of one or more other vehicles by examining the trip plan for the first vehicle.

For example, when schedules are generated for several vehicles to concurrently travel in the transportation network, the schedules may assume that all of the vehicles will primarily travel at or near speed limits of the transportation network when the vehicles are moving. The schedules may be coordinated so that vehicles do not block each other or cause slowdowns of each other (e.g., while one vehicle waits for another vehicle to move out of the way or pass), or so that such slowdowns are reduced relative to not coordinating the schedules with each other. One or more of the vehicles may generate a trip plan to reduce the emissions generated and/or fuel consumed by the one or more vehicles. This trip plan may cause the one or more vehicles to travel slower than the speed limits and/or slower than the speeds upon which the schedules of the vehicles are based. As a result, the one or more vehicles following the trip plan may move slower than expected by the creator of the schedules and consequently interfere with movements of other vehicles. For example, a first vehicle moving slower than expected and according to a trip plan may prevent a second vehicle from moving at or near a speed limit because the second vehicle is close behind the first vehicle, is required by a schedule to wait for the first vehicle to meet or pass the second vehicle, and the like. The schedule of the second vehicle may be modified in order to avoid or reduce wasteful waiting or changes in the movement of the second vehicle, such as by changing a path taken by the second vehicle, changing a time at which the second vehicle is to meet or pass the first vehicle, and the like.

In another embodiment, a system is provided that includes a scheduling unit and a communication unit. One or more of the units may alternatively be referred to as modules. As used herein, the terms “unit” or “module” include a hardware and/or software system that operates to perform one or more functions. For example, a unit or module may include one or more computer processors, controllers, and/or other logic-based devices that perform operations based on instructions stored on a tangible and non-transitory computer readable storage medium, such as a computer memory. Alternatively, a unit or module may include a hard-wired device that performs operations based on hard-wired logic of a processor, controller, or other device. The units or modules shown in the attached figures may represent the hardware that operates based on software or hardwired instructions, the software that directs hardware to perform the operations, the computer readable storage medium having the instructions that direct one or more operations, or a combination thereof.

The scheduling unit is configured to form a first schedule for a first vehicle to travel in a transportation network. The first schedule includes a first arrival time of the first vehicle at a scheduled location. The communication unit is configured to receive a first trip plan for the first vehicle from an energy management system. The first trip plan is based on the first schedule and designates at least one of tractive efforts or braking efforts to be provided by the first vehicle to reduce at least one of an amount of energy consumed by the first vehicle or an amount of emissions generated by the first vehicle when the first vehicle travels through the transportation network to the scheduled location. The scheduling unit also is configured to determine whether to modify the first schedule to avoid interfering with movement of one or more other vehicles by examining the trip plan for the first vehicle.

In another embodiment, a method is provided that includes receiving a first schedule for a first vehicle to travel in a transportation network from a scheduling system. The first schedule includes a first arrival time of the first vehicle at a scheduled location. The method also includes forming a first trip plan for the first vehicle based on the first schedule. The trip plan designates at least one of tractive efforts or braking efforts to be provided by the first vehicle to reduce at least one of an amount of energy consumed by the first vehicle or an amount of emissions generated by the first vehicle when the first vehicle travels through the transportation network to the scheduled location. The method further includes communicating the first trip plan to the scheduling system so that the scheduling system can examine the first trip plan and determine whether to modify the first schedule based on the first trip plan.

In another embodiment, a system is provided that includes a communication unit and an energy management unit. The communication unit is configured to receive a first schedule for a first vehicle to travel in a transportation network from a scheduling system. The first schedule includes a first arrival time of the first vehicle at a scheduled location. The energy management unit is configured to form a first trip plan for the first vehicle based on the first schedule. The trip plan designates at least one of tractive efforts or braking efforts to be provided by the first vehicle to reduce at least one of an amount of energy consumed by the first vehicle or an amount of emissions generated by the first vehicle when the first vehicle travels through the transportation network to the scheduled location. The communication unit also is configured to communicate the first trip plan to the scheduling system so that the scheduling system can examine the first trip plan and determine whether to modify the first schedule based on the first trip plan.

### BRIEF DESCRIPTION OF THE DRAWINGS

The present inventive subject matter will be better understood from reading the following description of non-limiting embodiments, with reference to the attached drawings, wherein below:

FIG. 1 is a schematic diagram of one embodiment of a transportation network;

FIG. 2 is a schematic illustration of one embodiment of a scheduling system shown in FIG. 1;

FIG. 3 is a schematic illustration of one embodiment of a vehicle shown in FIG. 1;

FIG. 4 illustrates a meet event between two vehicles at a first point in time and in accordance with one embodiment;

FIG. 5 illustrates the meet event of FIG. 4 at a subsequent, second point in time;

FIG. 6 illustrates the meet event of FIGS. 4 and 5 at a subsequent, third point in time;

FIG. 7 illustrates speed profiles for vehicles shown in FIGS. 4 through 6 in accordance with one embodiment;

FIG. 8 illustrates a meet event between the vehicles of FIGS. 4 through 6 at a first point in time with at least one of the vehicles traveling according to a modified trip plan in accordance with one embodiment;

FIG. 9 illustrates the meet event of FIG. 8 at a subsequent, second point in time;

FIG. 10 illustrates the meet event of FIGS. 8 and 9 at a subsequent, third point in time;

FIG. 11 illustrates a pass event between vehicles at a first point in time in accordance with one embodiment;

FIG. 12 illustrates the pass event of FIG. 11 at a subsequent, second point in time;

FIG. 13 illustrates the pass event of FIGS. 11 and 12 at a subsequent, third point in time;

FIG. 14 illustrates the pass event of FIGS. 11 through 13 at a subsequent, fourth point in time;

FIG. 15 illustrates speed profiles for the vehicles shown in FIGS. 11 through 14 in accordance with one embodiment;

FIG. 16 illustrates a pass event between the vehicles of FIGS. 11 through 14 at a first point in time with at least one of the vehicles traveling according to a modified trip plan in accordance with one embodiment;

FIG. 17 illustrates the pass event of FIG. 16 at a subsequent, second point in time; and

FIG. 18 is a flowchart of a method for scheduling movement of vehicles in a transportation network.

### DETAILED DESCRIPTION

One or more embodiments of the inventive subject matter described herein provide systems for generating schedules for vehicles to concurrently travel within a transportation network and energy management systems of the vehicles that create trip plans based on the schedules. The transportation network can be formed of plural interconnected routes, such as railroad tracks, roads, paths in water (e.g., marine shipping pathways), paths in air and/or space (e.g., airline routes), and the like. The vehicles may include powered units capable of self propulsion, such as automobiles, airplanes, or marine vessels, locomotives, or other off-highway vehicles. The schedules may direct the vehicles to travel along the routes to destination locations at associated arrival times. Additionally or alternatively, the schedules may include one or more waypoints on the way to the destination locations and associated times that the vehicles are to travel to or past the waypoints.

The energy management systems of the vehicles may create the trip plans such that the vehicles travel to the destination locations in such a way as to reduce an amount of energy consumed by the vehicles (e.g., by reducing an amount of fuel consumed by the vehicles) and/or to reduce an amount of emissions (e.g., gaseous emissions) generated by the vehicles, as described below. The trip plan of one or more of the vehicles may result in the vehicles deviating from the schedules. For example, the trip plans may cause vehicles to arrive at the scheduled destination location at a time that is later than a scheduled arrival time and/or to pass one or more waypoints when traveling toward the destination location later than the scheduled times associated with the waypoints. The trip plan may direct a vehicle to operate at a lower throttle setting to conserve fuel and/or reduce emissions, and thereby cause the vehicle to travel at a slower rate and arrive later than a scheduled arrival time.

The trip plan of one or more of the vehicles is communicated to the scheduling system for examination. The scheduling system analyzes the trip plan to determine if travel according to the trip plan will disrupt the travel of other vehicles in the transportation network. For example, the scheduling system may determine if a first vehicle traveling at a slower rate than expected (such as by traveling below a speed limit of the routes) will impede, block, or otherwise interfere with one or more other vehicles traveling to associated scheduled destination locations. If the trip plan will cause such a disruption, then the scheduling system may modify the schedules of one or more of the vehicles to avoid the disruption, as described below.

The scheduling system can track movements of the vehicles as the vehicles travel in the transportation network according to the trip plans. The scheduling system can monitor locations and/or speeds of the vehicles in order to determine if one or more of the vehicles are deviating from associated trip plans and/or schedules. For example, mechanical malfunction and/or damage to the vehicles and/or routes, previously unknown lower speed limits on the routes, and/or other unscheduled events or occurrences may cause some of the vehicles to fall behind associated schedules. A vehicle that falls behind schedule can impede travel of other vehicles, such as by taking up space on a one-way route or otherwise slowing or preventing movement of another vehicle in the transportation network.

The scheduling system can use the actual movements of the vehicles and update the schedules accordingly. For example, if a first vehicle is slowed or prevented from traveling to a scheduled destination location at a scheduled arrival time, the scheduling system can change the destination location, arrival time, and/or path to take to the destination location. The scheduling system can send the modified schedules to the energy management systems of the vehicles, which can modify the trip plans accordingly. The back and forth between the scheduling system generating schedules, the energy management systems creating trip plans based on the schedules, the scheduling system modifying one or more schedules based on the trip plans and/or tracking actual movement of the vehicles and modifying the schedules based on deviations from the schedules of the vehicles, and so on, can allow for the scheduling system and the energy management systems to provide for improved flow of travel in and/or through the transportation network while reducing energy consumed by the vehicles and/or emissions generated by the vehicles.

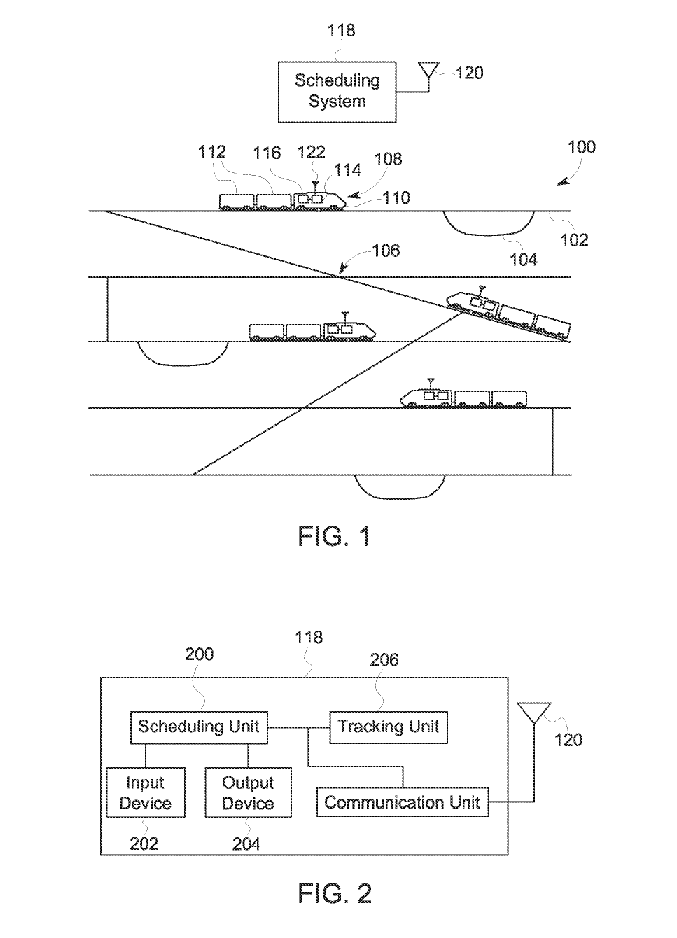

FIG. 1 is a schematic diagram of one embodiment of a transportation network 100. The transportation network 100 includes a plurality of interconnected routes 102, such as railroad tracks, roads, or other paths across which vehicles travel. The transportation network 100 may extend over a relatively large area, such as hundreds of square miles or kilometers of land area. In the illustrated embodiment, the routes 102 include siding sections 104 that allow vehicles traveling along the same or opposite directions to pass each other. The routes 102 also include intersections 106 between different sections of the routes 102. The number of routes 102, siding sections 104, and intersections 106 shown in FIG. 1 is meant to be illustrative and not limiting on embodiments of the described subject matter. Moreover, while one or more embodiments described herein relate to a transportation network formed from railroad tracks, not all embodiments are so limited. One or more embodiments may relate to transportation networks in which vehicles other than rail vehicles travel.

Several vehicles 108 may concurrently travel along the routes 102 in the transportation network 100. In the illustrated embodiment, the vehicles 108 are shown and described herein as rail vehicles or rail vehicle consists. However, one or more other embodiments may relate to vehicles other than rail vehicles or rail vehicle consists. While four vehicles 108 are shown in FIG. 1, alternatively, a different number of vehicles 108 may be concurrently traveling in the transportation network 100. The term “vehicle” may refer to an individual component, such as an individual powered unit (e.g., a vehicle capable of self propulsion, such as a locomotive, marine vessel, or other off-highway vehicle, or airplane, automobile, or the like), an individual non-powered unit (e.g., a vehicle incapable of self propulsion, such as a cargo or rail car), a group of powered and/or non-powered units mechanically and/or logically linked together (e.g., a train or other rail vehicle consist or other consist, or the like).

A vehicle 108 may include a group of powered units 110 (e.g., locomotives or other vehicles capable of self-propulsion) and/or non-powered units 112 (e.g., cargo cars, passenger cars, or other vehicles incapable of self-propulsion) that are mechanically coupled or linked together to travel along the routes 102 (such a vehicle is referred to as a vehicle consist). The routes 102 are interconnected to permit the vehicles 108 to travel over various combinations of the routes 102 to move from a starting location to a destination location. In the illustrated embodiment, the vehicles 108 include control systems 114 and propulsion subsystems 116. The control systems 114 generate control signals that are used to direct operations of the vehicles 108. For example, a control system 114 on a vehicle 108 may create control signals that are used to automatically change throttle settings and/or brake settings of a propulsion subsystem 116 of the vehicle 108. Alternatively, the control system 114 can generate control signals that cause an output device, such as an electronic display, monitor, speaker, tactile device, or other device, to visually, audibly, and/or tactually present instructions to an operator of the vehicle 108 to manually change the throttle settings and/or brake settings. The propulsion subsystem 116 includes components that propel the vehicle 108, such as one or more engines, traction motors, and the like, and/or one or more components that slow, stop, or otherwise effect movement of the vehicle 108, such as one or more brakes (e.g., air brakes, dynamic brakes, and the like).

The vehicles 108 travel along the routes 102 according to a movement plan of the transportation network 100. The movement plan includes schedules for the vehicles 108 to travel. For example, the movement plan may include schedules that direct different vehicles 108 to travel to various destination locations and/or waypoints at associated times, as described above. In one embodiment, the schedule for a vehicle 108 includes a list, table, or other logical arrangement of scheduled geographic locations (e.g., Global Positioning System coordinates) within and/or outside of the transportation network 100 and associated scheduled times that the vehicle 108 is to travel to or past the corresponding locations. In one embodiment, one or more schedules may direct the vehicles 108 to take a designated path (e.g., a designated combination of sections of the routes 102) to a destination location.

The schedules can include movement events between two or more vehicles 108. A movement event includes coordinated travel of the two or more vehicles 108 at a location to avoid the vehicles 108 hitting each other or coming within a designated safety distance of each other. Examples of movement events include meet events, pass events, divergence events, and convergence events.

A meet event involves a first vehicle 108 and a second vehicle 108 concurrently traveling in opposite directions along the same route 102. The first vehicle 108 pulls off of the route 102 onto a siding section route 104 that is joined with the route 102 while the second vehicle 108 passes the first vehicle 108 on the route 102. Once the second vehicle 108 has passed, the first vehicle 108 may pull back onto the route 102 from the siding section route 104 and continue to travel along the route 102 in an opposite direction as the second vehicle 108. A meet event may be included in the schedule of the first vehicle 108 in that the schedule may direct the first vehicle 108 to travel to a location of the siding section route 104 at a scheduled time, to pull onto the siding section route 104 for a designated time period, and/or to pull back onto the route 102 at another scheduled time. The meet event may be included in the schedule of the second vehicle 108 in that the schedule may direct the second vehicle 108 to arrive at the location of the meet event (e.g., where the siding section route 104 is located) at a scheduled time (e.g., after the first vehicle 108 is scheduled to pull onto the siding section route 104) and to continue along the route 102 past the meet event.

A pass event involves a first vehicle 108 and a second vehicle 108 concurrently traveling in the same or a common direction along the same route 102. A pass event alternatively may be referred to as an overtake event or an overtaking event. The first vehicle 108 leads the second vehicle 108 along the route 102. The first vehicle 108 pulls onto a siding section route 104 and allows the second vehicle 108 to pass on the route 102. The first vehicle 108 may then pull back onto the route 102 and follow the second vehicle 108. A pass event may be included in the schedule of the first vehicle 108 in that the schedule may direct the first vehicle 108 to travel to a location of the siding section route 104 at a scheduled time, to pull onto the siding section route 104 for a designated time period, and/or to pull back onto the route 102 at another scheduled time. The pass event may be included in the schedule of the second vehicle 108 in that the schedule may direct the second vehicle 108 to arrive at the location of the pass event (e.g., the location of the siding section route 104) at a scheduled time (e.g., after the first vehicle 108 is scheduled to pull onto the siding section route 104) and to continue along the route 102 past the pass event.

A divergence event involves a first vehicle 108 and a second vehicle 108 concurrently traveling in the same direction on the same or a common route 102 that splits into two or more diverging routes 102. The first vehicle 108 may lead the second vehicle 108 and may pull off of the common route 102 onto a first route 102 of the diverging routes 102. The second vehicle 108 may pull off of the common route 102 onto a different, second route 102 of the diverging routes 102 after the first vehicle 108 has pulled onto the first diverging route 102. The divergence event may be included in the schedule of the first vehicle 108 in that the schedule may direct the first vehicle 108 to travel to the location where the common route 102 diverges into the diverging routes 102 at a scheduled time and/or to pull onto the first diverging route 102 at a scheduled time. The divergence event may be included in the schedule of the second vehicle 108 in that the schedule may direct the second vehicle 108 to travel to the location where the common route 102 diverges at a time that is later than the scheduled time of the first vehicle 108 and/or to pull onto the second diverging route 102 at a scheduled time that is later than the scheduled time of the first vehicle 108.

A convergence event involves a first vehicle 108 and a second vehicle 108 concurrently traveling on different routes 102 that converge into a common route 102, with the first and second vehicles 108 traveling toward the common route 102. The first vehicle 108 pulls onto the common route 102 ahead of the second vehicle 108 and the first and second vehicles 108 continue to travel in the same direction along the common route 102. The convergence event may be included in the schedule of the first vehicle 108 in that the schedule may direct the first vehicle 108 to pull onto the common route 102 at a scheduled time. The convergence event may be included in the schedule of the second vehicle 108 in that the schedule may direct the second vehicle 108 to pull onto the common route 102 at a later scheduled time.

The schedules and/or movement plan may be determined by a scheduling system 118. As shown in FIG. 1, the scheduling system 118 can be disposed off-board (e.g., outside) the vehicles 108. For example, the scheduling system 118 may be disposed at a central dispatch office for a railroad company. Alternatively, the scheduling system 118 can be disposed on-board one or more of the vehicles 108. The scheduling system 118 can create and communicate the schedules to the vehicles 108. For example, the scheduling system 118 can include a wireless antenna 120 (and associated transceiving equipment), such as a radio frequency (RF) or cellular antenna, that wirelessly transmits the schedules to wireless antennas 122 of the vehicles 108. The antennas 122 of the vehicles 108 may be communicatively coupled with the control systems 114 of the vehicles 108 to convey the schedules to the vehicles 108.

The schedules may be generated based on relative priorities between the vehicles 108. For example, in one embodiment, given a finite set of routes 102 in the transportation network 100 that are available for the vehicles 108 to travel along, the vehicles 108 may be prioritized such that vehicles 108 having higher priorities travel along one or more routes 102 before other vehicles 108 having lower priorities. The priorities may be based on one or more factors such as a financial value of a shipping or transportation contract related to the transport of cargo and/or passengers by the vehicles 108, sizes (e.g., weight and/or length) of the vehicles 108, distances to be traveled by the vehicles 108 to associated destination locations, geographic positions of the destination locations of the vehicles 108, and the like. The schedules may be based on the priorities by scheduling earlier arrival times for the vehicles 108 having higher priorities. In another example, the schedules may be based on the priorities by scheduling different paths along the routes 102 to the destination locations based on the priorities (e.g., by scheduling a shorter and/or more direct path for a higher priority vehicle 108 relative to a lower priority vehicle 108).

The control system 114 may form a trip plan for a trip of the vehicle 108 to travel according to the schedule of the vehicle 108. For example, the control system 114 may generate the trip plan to cause the vehicle 108 to travel to a scheduled destination location at a scheduled arrival time. The trip plan may include throttle settings, brake settings, designated speeds, or the like, of the vehicle 108 for various sections of the trip of the vehicle 108 from a current or starting location to the destination location. For example, the trip plan can include one or more velocity curves that designate various speeds of the vehicle 108 along various sections of the routes 102. The trip plan can be used by the control system 114 to determine the tractive efforts and/or braking efforts of the propulsion subsystem 116 for the trip. The control system 114 may form the control signals based on the trip plan.

In one embodiment, the trip plan is formed by the control system 114 to reduce an amount of energy (e.g., fuel) that is consumed by the vehicle 108 and/or to reduce an amount of emissions generated by the vehicle 108 as the vehicle 108 travels to the destination location associated with the received schedule. The trip plan can include throttle settings, brake settings, designated speeds, or the like, that causes the vehicle 108 to be propelled to the scheduled destination location in a manner that consumes less energy (e.g., fuel) and/or produces less emissions than if the vehicle 108 traveled to the scheduled destination location in another manner. As one example, the vehicle 108 may consume less fuel and/or produce less emissions in traveling to the destination location according to the trip plan than if the vehicle 108 traveled to the same destination location while traveling without using the trip plan, such as by traveling at another predetermined speed (e.g., a speed limit of the routes 102, which may be referred to as “track speed”). The trip plan may result in the vehicle 108 arriving at the scheduled destination later than the scheduled arrival time. For example, following the trip plan may cause the vehicle 108 to arrive later than the scheduled arrival time, but within a predetermined range of time after the scheduled arrival time.

In one embodiment, the scheduling system 118 can use the trip plans sent by the vehicles 108 as an initial guide as to where the vehicles 108 will be located at various times during travel in the transportation network 100. Based on the trip plans, the scheduling system 118 can determine whether the schedules of one or more vehicles 108 need to be updated. For example, one or more of the vehicles 108 communicate the trip plans formed by the control systems 114 to the scheduling system 118. The scheduling system 118 may examine the trip plans to determine if one or more schedules of the vehicles 108 need to be modified. For example, the trip plan of one or more vehicles 108 may result in the vehicles 108 arriving at scheduled destination locations later than the scheduled arrival times. As another example, a trip plan may cause a vehicle 108 to arrive at a movement event, such as a pass event, meet event, convergence event, and/or divergence event, later than a scheduled time. If the vehicle 108 falls sufficiently behind schedule, the vehicle 108 may not arrive at the movement event in time to avoid interfering with another vehicle 108. For example, a first vehicle 108 may be traveling behind schedule such that the first vehicle 108 may be unable or unlikely to avoid collision with, or to avoid coming within a designated safety distance from, another vehicle 108 in a movement event.

If the scheduling system 118 determines that the trip plan of one or more of the vehicles 108 will or is likely to cause interference with the movement of one or more other vehicles 108, then the scheduling system 118 may change the schedules of one or more of the vehicles 108, as described below. For example, the scheduling system 118 may delay the time that one or more vehicles 108 are scheduled to arrive at, pass, or otherwise participate in a movement event. The delayed times may cause the vehicles 108 to be able to participate in the movement event without colliding and/or coming within the designated safety distance from each other. The changes to the schedules may be communicated from the scheduling system 118 to the vehicles 108, such as prior to the vehicles 108 traveling according to the schedules or while the vehicles 108 are moving.

In one embodiment, the scheduling system 118 tracks movements of the vehicles 108 as the vehicles 108 travel according to the schedules and/or trip plans. The scheduling system 118 may monitor actual movement of the vehicles 108 in order to determine if the schedules of one or more of the vehicles 108 needs to be changed. For example, after commencing various trips of the vehicles 108, the scheduling system 118 may periodically or continuously check on current positions (e.g., geographic coordinates, distances along the routes 102 from designated reference points, and the like) and/or actual speeds of the vehicles 118 in order to determine if one or more of the vehicles 108 are significantly deviating from associated schedules. A significant deviation from a schedule may include the vehicle 108 arriving at and/or passing by a location (e.g., a waypoint, movement event, starting location, or other location) later than a scheduled time by more than a designated time threshold. For example, a vehicle 108 that arrives at or passes by a scheduled location more than 20 minutes later than a scheduled time for that location may be considered to have significantly deviated from the schedule when the time threshold is 20 minutes or less. As another example, a significant deviation from a schedule may include a vehicle 108 arriving at or passing by at least a threshold number or percentage of scheduled locations later than associated scheduled times.

The scheduling system 118 can modify the schedules of one or more vehicles 108 based on the actual movements of the vehicles 108. For example, if the scheduling system 118 determines that a vehicle 108 has significantly deviated from a schedule of the vehicle 108, then the scheduling system 118 can change the schedule of that vehicle 108 and/or one or more other vehicles 108 to account for the significant deviation. The changes to the schedules can include delaying a scheduled time and/or changing a location of a movement event, changing a scheduled arrival time at a destination location, changing the destination location, changing a path to be taken to the destination location, and the like.

When the scheduling system 118 modifies the schedules, the scheduling system 118 may communicate the modified schedules to the vehicles 108. The vehicles 108 may receive the modified schedules and the control systems 114 of the vehicles 108 can modify the trip plans of the vehicles 108. For example, based on a changed destination location, arrival time, path to be taken to the destination location, and the like, the control systems 114 may change a speed profile (e.g., one or more throttle settings and/or brake settings of the propulsion subsystems 116) so that the vehicle 108 consumes less energy and/or produces less emissions when traveling to the destination location according to the modified schedule.

The control systems 114 may then transmit the modified trip plans to the scheduling system 118 so that the scheduling systems 118 can determine whether to further modify the schedules, similar to as described above. If any schedules are modified based on the modified trip plans, the control systems 114 can modify one or more trip plans based on the modified schedules. This type of feedback loop between the scheduling system 118 and the control systems 114 can permit the scheduling system 118 and the control systems 114 to work together to coordinate the concurrent movement of several vehicles 108 in the transportation system 100 while reducing the energy consumed and/or emissions produced by the vehicles 108.

FIG. 2 is a schematic illustration of one embodiment of the scheduling system 118. The scheduling system 118 includes several units that perform various operations described herein. The scheduling system 118 includes a scheduling unit 200 that generates and/or modifies the schedules of the vehicles 108 (shown in FIG. 1). As described above, the scheduling unit 200 can create the schedules based on relative priorities of the vehicles 108. Alternatively, the scheduling unit 200 can create the schedules based on a feasibility of moving the vehicles 108 to associated destination locations. For example, the scheduling unit 200 may generate the schedules so as to avoid two or more vehicles 108 occupying the same space at the same time. In another embodiment, the scheduling unit 200 can receive one or more schedules as input from an operator. For example, the scheduling system 118 may include an input device 202, such as a keyboard, microphone, touchscreen, electronic mouse, joystick, or other device, that is controlled by an operator of the scheduling system 118 to designate the schedules (or portions thereof), modify the schedules, priorities, travel restrictions (e.g., speed restrictions, horsepower restrictions, areas of the routes 102 shown in FIG. 1 over which a vehicle 108 cannot travel), and the like, for one or more vehicles 108.

The scheduling system 118 includes an output device 204, such as an electronic display, monitor, speaker, tactile device, or other device, that visually, audibly, and/or tactually notifies an operator of output information. The output information may be alarms (e.g., to notify of a significant deviation from a schedule by a vehicle 108 shown in FIG. 1), schedules of the vehicles 108, modifications to the schedules, trip plans, modifications to the trip plans, and the like.

The scheduling system 118 includes a tracking unit 206 that monitors actual movement of the vehicles 108 in the transportation system 100 (shown in FIG. 1). The tracking unit 206 may track the movement of the vehicles 108 (shown in FIG. 1) by receiving reports of location information (e.g., geographic locations and/or speeds) of the vehicles 108. For example, the vehicles 108 may, periodically or upon demand from the scheduling system 118, report the speeds of the vehicles 108 to the tracking unit 206 and the tracking unit 206 may calculate a location of the vehicles 108 based on the speeds and the times since the vehicles 108 left reference or starting locations. Alternatively, the vehicles 108 may include location determining devices 300, such as Global Positioning System (GPS) receivers, that determine locations of the vehicles 108. The vehicles 108 may then transmit the locations to the tracking unit 206. In another example, one or more devices disposed alongside the route 102 (shown in FIG. 1), such as wayside devices that detect a presence of a passing vehicle 108, can report the detection of the vehicles 108 to the tracking unit 206 as the vehicles 108 pass the devices. The tracking unit 206 may then determine locations of the vehicles 108 based on the known locations of the devices.

A communication unit 208 of the scheduling system 118 communicates with the vehicles 108 (shown in FIG. 1) and/or one or more other devices. For example, the communication unit 208 may be communicatively coupled with the antenna 120 to transmit schedules, modified schedules, modifications to schedules, and the like, to the control systems 114 of the vehicles 108. The communication unit 208 can receive information from the vehicles 108 and/or other devices, such as by receiving trip plans, modified trip plans, modifications to trip plans, speeds of the vehicles 108, locations of the vehicles 108, detection of vehicles 108 from devices alongside the routes 102, and the like. The communication unit 208 may receive such information via the antenna 120.

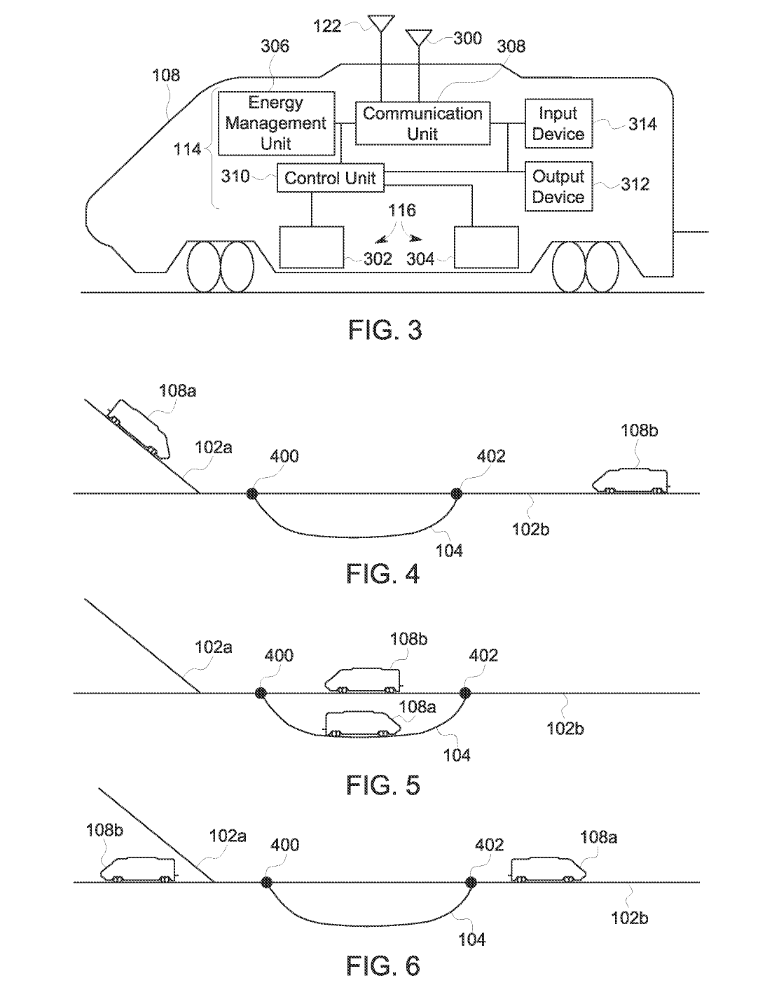

FIG. 3 is a schematic illustration of one embodiment of one of the vehicles 108. Several components of the vehicle 108 are shown in FIG. 3 as being connected with each other. The connections between the components are meant to represent operative or communication connections between the components. For example, the connections may represent wired and/or wireless connections, such as busses, wires, network connections, and the like. Alternatively, a connection between two or more of the components may be eliminated and the components may be included in a single component or device.

As described above, the vehicle 108 includes the control system 114, which is communicatively coupled with the propulsion subsystem 116 of the vehicle 108. As shown in FIG. 3, the propulsion subsystem 116 includes one or more motive assemblies 302 and one or more braking assemblies 304. The motive assembly 302 shown in FIG. 3 may include or represent an engine, alternator and/or generator, motors, and the like, that convert fuel into tractive effort used to propel the vehicle 108. The braking assembly 304 shown in FIG. 3 may include or represent one or more brakes, such as air brakes, dynamic brakes, and the like.

The control system 114 includes an energy management unit 306. The energy management unit 306 forms the trip plans for the vehicle 108 that are used to control operations of the propulsion subsystem 116 of the vehicle 108 during a trip of the vehicle 108. A trip of the vehicle 108 includes the travel of the vehicle 108 along the route 102 from a starting location to a scheduled destination location. The energy management unit 308 can form a trip plan for a trip of the vehicle 108 that is dictated by the schedule (or a modified schedule) received from the scheduling system 118, as described above.

In one embodiment, the energy management unit 306 includes a software application or system such as the Trip Optimizer™ system provided by General Electric Company. The energy management unit 306 can use trip data, vehicle data, route data, and/or an update to trip data, vehicle data, or route data to form a trip plan for the vehicle 108.

Trip data includes information about the path taken by the vehicle 108 to travel to a scheduled destination location. By way of example, trip data may include a trip profile of an upcoming trip of the vehicle 108 (such as information that can be used to control one or more operations of the vehicle 108, including tractive and/or braking efforts provided by the vehicle 108 during the trip), station information (such as the location of a beginning station where the upcoming trip is to begin and/or the location of an ending station where the upcoming trip is to end), restriction information (such as work zone identifications, or information on locations where the route 102 shown in FIG. 1 is being repaired or is near another route 102 being repaired and corresponding speed/throttle limitations on the vehicle 108), and/or operating mode information (such as speed/throttle limitations on the vehicle 108 in various locations, slow orders, and the like).

Vehicle data includes information about the vehicle 108 and/or cargo being carried by the vehicle 108. For example, vehicle data may represent cargo content (such as information representative of cargo being transported by the vehicle 108) and/or vehicle information (such as model numbers, manufacturers, horsepower, and the like, of the vehicle 108).

Route data includes information about the route 102 (shown in FIG. 1) upon which the vehicle 108 is to travel to reach the destination location. For example, the route data can include information about locations of damaged sections of a route 102, locations of sections of the route 102 that are under repair or construction, the curvature and/or grade of a route 102, GPS coordinates of the route 102, and the like.

The energy management unit 306 can receive at least some of the above data to form the trip plan from an offboard source (e.g., a system, device, assembly, and the like, located off of the vehicle 108), such as the scheduling system 118 (shown in FIG. 1). Alternatively, the control system 114 of the vehicle 108 may receive the trip plan from the offboard source.

The energy management unit 306 can communicate with a control unit 310 of the control system 114. The control unit 310 generates control signals that are used to control the tractive efforts and/or braking efforts provided by the propulsion subsystem 116 of the vehicle 108. For example, the control unit 310 can form the control signals based on the trip plan that are transmitted to the motive assemblies 302 and/or braking assemblies 304 to change the tractive efforts and/or braking efforts provided by the assemblies 302, 304. The control signals may be transmitted to the propulsion subsystem 116 to automatically control the tractive efforts and/or braking efforts. Alternatively, the control signals may be transmitted to an output device 312, such as an electronic display, monitor, speaker, tactile device, or other device, that visually, audibly, and/or tactually notifies an operator of the throttle settings, brake settings, and/or changes thereto in accordance with the trip plan.

The control system 114 includes a communication unit 308 that controls communication with the vehicle 108. For example, the communication unit 308 may be communicatively coupled with the antenna 122 to communicate with the scheduling system 118 (shown in FIG. 1) and/or other offboard components. The communication unit 308 can be communicatively coupled with the location determining device 300 to determine locations and/or speeds of the vehicle 108. The communication unit 308 can receive the schedules and/or modifications to the schedules from the scheduling system 118. The communication unit 308 can transmit tracking data indicative of actual movement of the vehicle 108, such as locations and/or speeds of the vehicle 108, to the scheduling system 118, as described above. The communication unit 308 may transmit the trip plans and/or modifications to the trip plans to the scheduling system 118, also as described above.

The vehicle 108 includes an input device 314, such as a keyboard, microphone, touchscreen, electronic mouse, joystick, or other device, that is controlled by an operator of the vehicle 108 to convey information to the control system 114. For example, the operator may use the input device 314 to control throttle settings, brake settings, modify trip plans, and the like.

The scheduling system 118 (shown in FIG. 1) and the control system 114 can work together to coordinate travel of the vehicles 108 in the transportation network 100 while reducing the amounts of energy consumed by the vehicles 108 and/or the amounts of emissions generated by the vehicles 108. As described above, the scheduling system 118 may form and communicate a schedule to vehicles 108 that includes a meet event. The vehicles 108 involved in the meet event form trip plans based on the schedules.

FIGS. 4 through 6 illustrate a meet event between two vehicles 108a, 108b in accordance with one embodiment at different times during the meet event. The scheduling system 118 communicates a scheduled meet event to the vehicles 108a, 108b that involves the first vehicle 108a traveling from a first route 102a to a second route 102b and traveling on the second route 102b to the location of a siding section route 104 (as shown in FIG. 4), with the first and second vehicles 108a, 108b traveling in opposite directions on the second route 102b. The schedule directs the first vehicle 108a to pull off of the second route 102b and onto the siding section route 104 at a first scheduled time (as shown in FIG. 5) and at a first location 400.

The schedule of the second vehicle 108b directs the second vehicle 108b to travel to the siding section route 104 and pass by the siding section route 104 at a scheduled time that is after when the first vehicle 108a is scheduled to pull onto the siding section route 104 (as shown in FIG. 5). The schedule of the first vehicle 108a directs the first vehicle 108a to pull back onto the second route 102b after the second vehicle 108b has passed (as shown in FIG. 6) at a second location 402.

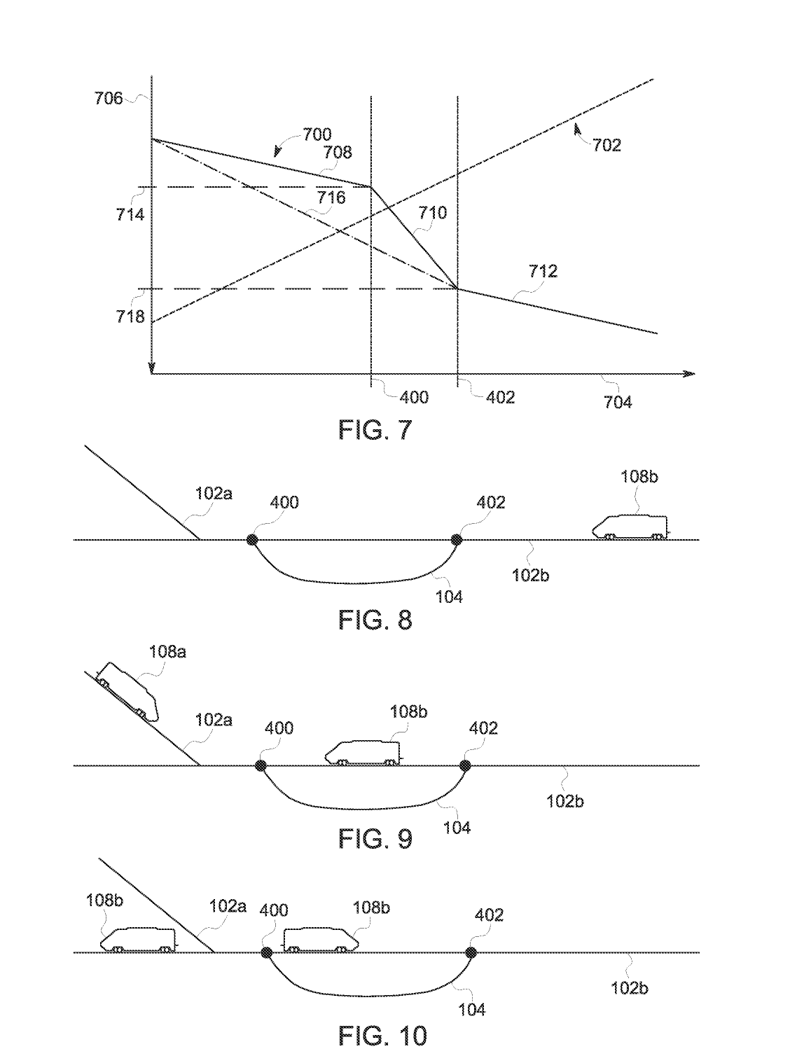

FIG. 7 illustrates speed profiles 700, 702 for the first and second vehicles 108a, 108b (shown in FIGS. 4 through 6) in accordance with one embodiment. The speed profiles 700, 702 represent speeds at which the vehicles 108a, 108b are directed to travel in order to move according to the schedules generated by the scheduling system 118 (shown in FIG. 1). The speed profiles 700, 702 are shown alongside a horizontal axis 704 representative of distance along the second route 102b and a vertical axis 706 representative of time. The speed profiles 700, 702 of the vehicles 108a, 108b are shown as having negative and positive slopes, respectively, due to the opposite directions of travel of the first vehicle 108a and the second vehicle 108b. In the illustrated example, a smaller slope of a speed profile 700, 702 (e.g., a smaller absolute value of the slope) indicates a faster speed of the corresponding vehicle 108a, 108b while larger slopes (e.g., larger absolute values of the slopes) indicate slower speeds.

As shown in FIG. 7, the first vehicle 108a travels to the first location 400 of the meet event (represented by a vertical line in FIG. 7) according to a first section 708 of the speed profile 700. The first vehicle 108a arrives at the first section 708 at a first scheduled time 714 and pulls onto the siding section route 104 (shown in FIGS. 4 through 6) and slows down, as shown by a second section 710 of the speed profile 700 between the first and second locations 400, 402 of the meet event. The second vehicle 108b approaches the meet event and passes the siding section route 104 according to the second speed profile 702, as shown in FIG. 7. After the second vehicle 108b has passed the siding section route 104, the first vehicle 108a pulls back onto the second route 102b at the second location 402 and continues along the second route 102b according to a third section 712 of the speed profile 700.

As described above, upon receiving the schedule from the scheduling system 118 (shown in FIG. 1), the control system 114 (shown in FIG. 1) of the first vehicle 108a may create a trip plan. The control system 114 of the first vehicle 108a may transmit the trip plan to the scheduling system 118 and the scheduling system 118 can use the trip plan as an initial guide to where the first vehicle 108a will be located at various points during the trip of the first vehicle 108a. In one embodiment, the trip plan may result in the first vehicle 108a arriving at the first location 400 of the meet event later than the first time 714. Arriving later than the first time 714 may not provide the first vehicle 108a with sufficient time to pull off onto the siding section route 104 before the second vehicle 108b arrives. The scheduling system 118 may examine the trip plan of the first vehicle 108a and determine that the first vehicle 108a will, according to the trip plan, arrive at the meet event too late (e.g., after the second vehicle 108b has arrived at the meet event). The scheduling system 118 can examine the trip plan by calculating when the first vehicle 108a will arrive at the first location 400 of the meet event based on the speed of the first vehicle 108a as reflected by the first section 708 of the speed profile 700 and a distance between the first vehicle 108a and the meet event (e.g., by dividing the distance from the starting location or a current location of the first vehicle 108a by the planned speed of the vehicle 108). The scheduling system 118 can determine that the first vehicle 108a will or is likely to arrive late to the meet event and, as a result, the scheduling system 118 may modify the schedule of the first vehicle 108a.

Additionally or alternatively, the scheduling system 118 may track actual movement of the first vehicle 108a, as described above. For example, the scheduling system 118 may monitor actual movement of the first vehicle 108a as the first vehicle 108a moves toward the meet event. Based on the monitored movements of the first vehicle 108a, the scheduling system 118 can determine if the first vehicle 108a will or is likely to arrive at the meet event later than the first time 714, similar to as described above. The scheduling system 118 can determine that the first vehicle 108a will or is likely to arrive late to the meet event and, as a result, the scheduling system 118 may modify the schedule of the first vehicle 108a.

In another embodiment, the scheduling system 118 may examine the schedules and/or trip plans of the vehicles 108a, 108b to determine if one or more movement events, such as the meet event, can be avoided. A movement event that involves the first vehicle 108a significantly slowing down and/or stopping while remaining in an engine idle state on the siding section route 104 can consume more energy and/or produce more emissions than the first vehicle 108a avoiding the movement event. For example, the scheduling system 118 may determine that the first vehicle 108a will or is likely to burn less fuel and/or produce fewer emissions by traveling at a slower speed to the siding section route 104 such that the first vehicle 108a avoids the meet event and avoids moving to the siding section route 104. The scheduling system 118 may make this determination by calculating how much fuel is consumed and/or emissions generated by the first vehicle 108a from previous trips of the first vehicle 108a, by using known relationships between fuel consumption or emission generation, the path traveled by the first vehicle 108a, and/or the speeds of the first vehicle 108a.

In one embodiment, the scheduling system 118 may change the schedule of the first vehicle 108a by delaying the time at which the first vehicle 108a is scheduled to arrive at the meet event. For example, the scheduling system 118 may push back the scheduled time of arrival of the first vehicle 108a at the first location 400 until after the second vehicle 108b has passed the siding section route 104 and is no longer traveling toward the first vehicle 108a on the second route 102b. With respect to the example shown in FIGS. 4 through 6, the scheduling system 118 may delay the arrival of the first vehicle 108a such that the first vehicle 108a does not move from the first route 102a onto the second route 102b until after the second vehicle 108b has passed the first route 102a.

As described above, the scheduling system 118 communicates the change in the schedule of the first vehicle 108a to the first vehicle 108a. In one embodiment, the scheduling system 118 sends the change in the schedule to the first vehicle 108a as the first vehicle 108a is moving toward the meet event. In the example shown in FIG. 7, the scheduling system 118 may send a delayed arrival time 718 to the first vehicle 108a. The first vehicle 108a receives the change in the schedule and may modify the trip plan of the first vehicle 108a. For example, the first vehicle 108a may change the first and second sections 708, 710 of the speed profile 700 to a modified section 716 of the speed profile 700.

With continued reference to FIG. 7, FIGS. 8 through 10 illustrate the meet event with the first vehicle 108a traveling according to the modified trip plan in accordance with one embodiment at different times. Travel of the first vehicle 108a according to the modified section 716 involves the first vehicle 108a traveling at a slower speed such that the first vehicle 108a arrives at the meet event after the second vehicle 108b has passed the meet location (shown in FIG. 10). For example, the first vehicle 108a may slow down such that the second vehicle 108b has passed the intersection of the first route 102a and the second route 102b before the first vehicle 108a pulls onto the second route 102b (shown in FIG. 10).

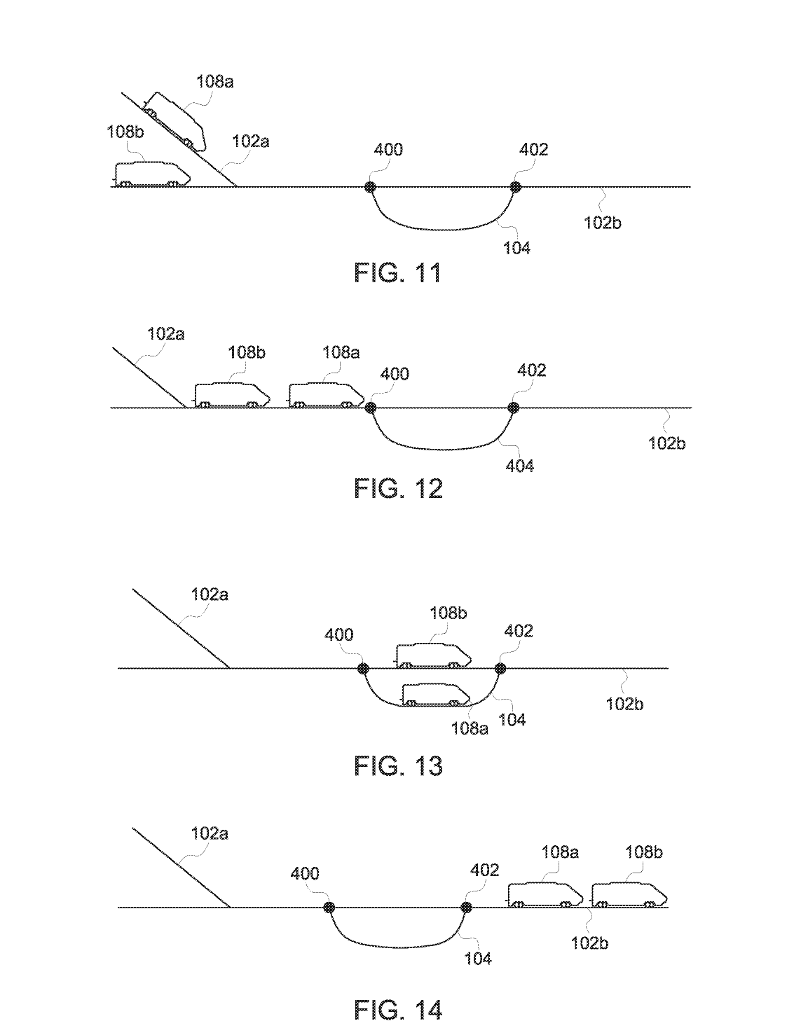

FIGS. 11 through 14 illustrate a pass event between the vehicles 108a, 108b in accordance with one embodiment at different times during the pass event. The scheduling system 118 communicates a scheduled pass event to the vehicles 108a, 108b that involves the first vehicle 108a traveling from the first route 102a to the second route 102b (shown in FIGS. 11 and 12) and traveling on the second route 102b ahead of the second vehicle 108b and in the same direction (shown in FIG. 12). The schedule of the first vehicle 108a directs the first vehicle 108a to travel to the location of the siding section route 104 and to pull off of the second route 102b and onto the siding section route 104 at a first scheduled time (as shown in FIG. 13) and at the first location 400.

The schedule of the second vehicle 108b directs the second vehicle 108b to travel to the siding section route 104 and pass by the siding section route 104 at a time that is after when the first vehicle 108a is scheduled to pull onto the siding section route 104 (as shown in FIG. 13). The schedule of the first vehicle 108a directs the first vehicle 108a to pull back onto the second route 102b after the second vehicle 108b has passed (as shown in FIG. 14) the second location 402.

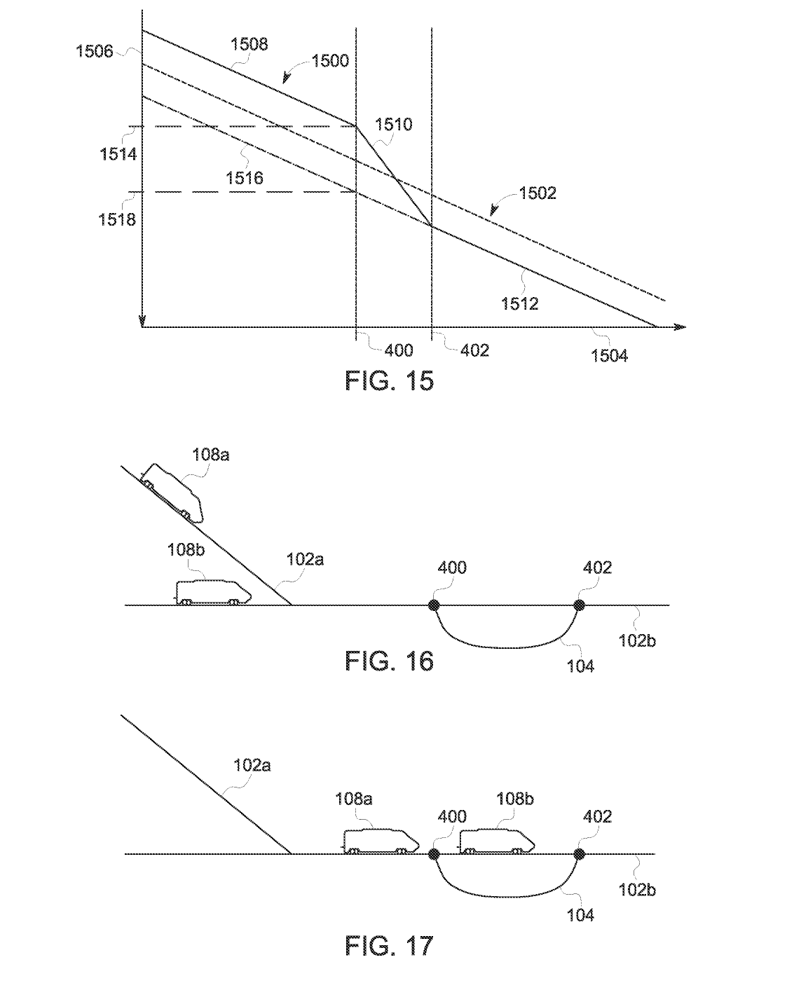

FIG. 15 illustrates speed profiles 1500, 1502 for the first and second vehicles 108a, 108b during the pass event shown in FIGS. 11 through 14 in accordance with one embodiment. Similar to the speed profiles 700, 702 (shown in FIG. 7), the speed profiles 1500, 1502 are shown alongside a horizontal axis 1504 representative of distance along the second route 102b and a vertical axis 1506 representative of time. The speed profiles 1500, 1502 are shown as having negative slopes due to the same direction of travel of the first vehicle 108a and the second vehicle 108b.

As shown in FIG. 15, the first vehicle 108a travels to the first location 400 of the pass event according to a first section 1508 of the speed profile 1500. The first vehicle 108a arrives at the first section 708 at a first scheduled time 1514 and pulls onto the siding section route 104 (as shown in FIG. 13). The first vehicle 108a then slows down, as shown by a second section 1510 of the speed profile 1500 between the first and second locations 400, 402 of the pass event. The second vehicle 108b approaches the pass event and passes the siding section route 104 according to the second speed profile 1502. After the second vehicle 108b has passed the siding section route 104, the first vehicle 108a pulls back onto the second route 102b at the second location 402 and continues along the second route 102b according to a third section 1512 of the speed profile 1500.

In one embodiment, the scheduling system 118 (shown in FIG. 1) may examine the schedules, trip plans, and/or actual movements of the vehicles 108a, 108b in order to determine if the energy consumed and/or emissions generated by one or more of the vehicles 108a, 108b can be reduced. For example, the scheduling system 118 can examine the schedules and/or trip plans to determine if one or more movement events, such as a pass event, can be avoided, similar to as described above. In another example, the scheduling system 118 can monitor actual movement of the first vehicle 108a and may determine that, due to one or more conditions of the first vehicle 108a, the routes 102, or other factors, that the first vehicle 108a is unable to travel at the speeds directed by the trip plan of the first vehicle 108a. In response, the scheduling system 118 may determine that the first vehicle 108a can avoid the pass event by approaching the siding section route 104 slowly enough to permit the second vehicle 108b to pull ahead of the first vehicle 108a before the first vehicle 108a moves from the first route 102a to the second route 102b.

In one embodiment, the scheduling system 118 may change the schedule of the first vehicle 108a by delaying the time at which the first vehicle 108a is scheduled to arrive at the pass event. For example, the scheduling system 118 may push back the scheduled time of arrival of the first vehicle 108a at the first location 400 such that the second vehicle 108b has already passed the first vehicle 108a when the first vehicle 108a pulls onto the second route 102b. The scheduling system 118 communicates the change in the schedule of the first vehicle 108a to the first vehicle 108a. In one embodiment, the scheduling system 118 sends the change in the schedule to the first vehicle 108a as the first vehicle 108a is moving toward the movement event. In the example shown in FIG. 15, the scheduling system 118 may send a delayed arrival time 1518 to the first vehicle 108a. The first vehicle 108a receives the change in the schedule and may modify the trip plan of the first vehicle 108a. For example, the first vehicle 108a may change the first and second sections 1508, 1510 of the speed profile 1500 to a modified section 1516 of the speed profile 700.

With continued reference to FIG. 15, FIGS. 16 and 17 illustrate the pass event with the first vehicle 108a traveling according to the modified trip plan in accordance with one embodiment at different times. Travel of the first vehicle 108a according to the modified section 1516 involves the first vehicle 108a traveling at a slower speed such that the first vehicle 108a pulls onto the second route 102b after the second vehicle 108b has pulled ahead of the first vehicle 108a, as shown in FIG. 17. For example, the first vehicle 108a may slow down such that the second vehicle 108b has passed the intersection of the first route 102a and the second route 102b before the first vehicle 108a pulls onto the second route 102b.

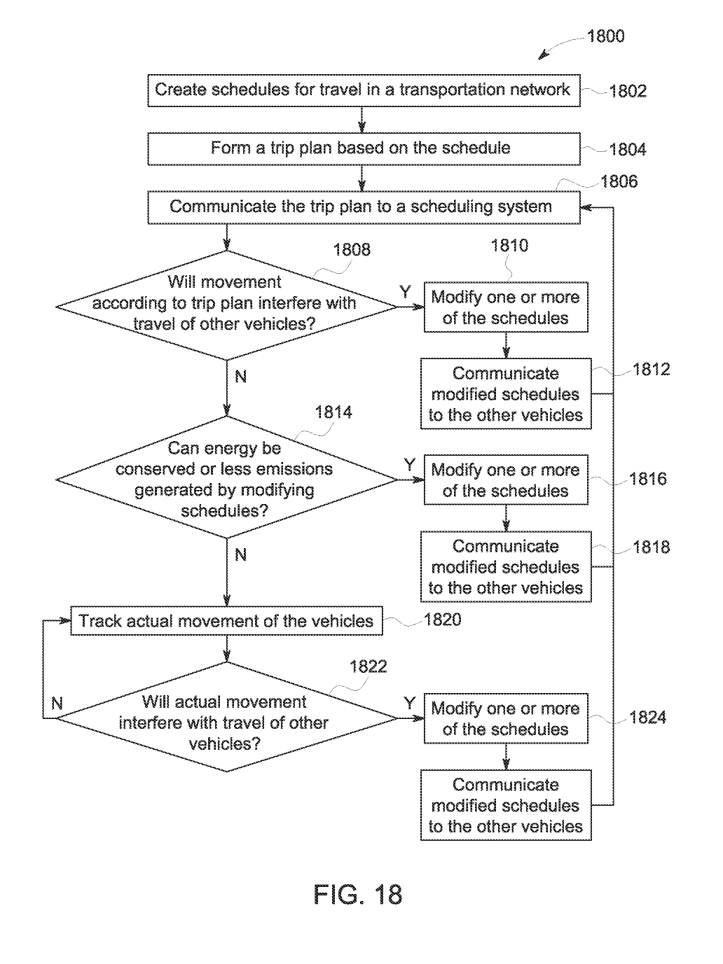

FIG. 18 is a flowchart of a method 1800 for scheduling movement of vehicles in a transportation network. The method 1800 may be used in conjunction with one or more embodiments of the scheduling system 118 (shown in FIG. 1) and/or the control systems 114 (shown in FIG. 1). For example, the method 1800 may be used to generate schedules and trip plans for the vehicles 108 (shown in FIG. 1), where the schedules and trip plans are communicated between the scheduling system 118 and the control systems 114 in a feedback loop that also may include monitoring the actual movements of the vehicles 108, and where the schedules and trip plans are modified based on each other.

At 1802, schedules are created for plural vehicles to concurrently travel in a transportation network. For example, the scheduling system 118 (shown in FIG. 1) can create schedules for the vehicles 108 (shown in FIG. 1) to travel to associated destination locations. The scheduling system 118 may coordinate travel of the vehicles 108 so that the vehicles 108 arrive at destination locations and/or travel according to relative priorities between one another. The scheduling system 118 may coordinate the schedules so that the flow of the vehicles 108 through the transportation network 100 is not significantly congested. The schedules are communicated to the vehicles 108. Alternatively, the schedules may be communicated to another system (e.g., a system disposed off-board the vehicles 108) that forms trip plans based on the schedules.

At 1804, one or more trip plans are formed based on the schedules. For example, the control systems 114 (shown in FIG. 1) may create trip plans that direct tractive efforts and/or braking efforts of the vehicles 108 (shown in FIG. 1). The trip plans may be formed so that the vehicles 108 consume less energy and/or produce less emissions than if the vehicles 108 traveled to scheduled destination locations without following the trip plans, as described above.

At 1806, the one or more trip plans are communicated to the scheduling system 118 (shown in FIG. 1). For example, the control systems 114 (shown in FIG. 1) may transmit the trip plans of the vehicles 108 (shown in FIG. 1) to the scheduling system 118.

At 1808, a determination is made as to whether expected movement of the vehicles 108 (shown in FIG. 1) according to the trip plans of the vehicles 108 will or is likely to result in the movement of one or more vehicles 108 being interfered with. For example, the scheduling system 118 (shown in FIG. 1) may examine the trip plans to see if travel of one or more vehicles 108 according to associated trip plans will cause the vehicles 108 to arrive too late to a movement event. As described above, a vehicle 108 may arrive late to a movement event when the vehicle 108 that is scheduled to pull onto the siding section route 104 (shown in FIG. 1) during the event after another vehicle 108 has passed the siding section route 104. If a first vehicle 108 is too late to a movement event that also involves a second vehicle 108, then the travel of the second vehicle 108 may be interfered with, such as by requiring the second vehicle 108 to slow down or stop to allow the first vehicle 108 to arrive at the movement event.

If the trip plan will result in or is likely to result in a vehicle 108 (shown in FIG. 1) interfering with the movement of one or more other vehicles 108, then the schedule of the vehicle 108 may need to be modified to avoid interfering with the movement of the one or more other vehicles 108. As a result, flow of the method 1800 may proceed to 1810. On the other hand, if the trip plan will not result in or is unlikely to result in the vehicle 108 interfering with movement of one or more other vehicles 108, then the schedule of the vehicle 108 may not need to be modified. As a result, flow of the method 1800 may continue to 1814.

At 1810, the schedules of one or more of the vehicles 108 (shown in FIG. 1) are modified. For example, the scheduling system 118 (shown in FIG. 1) may delay a scheduled time of a movement event for at least one of the vehicles 108 involved in the movement event. Delaying the time of the event may result in at least one of the vehicles 108 avoiding the event. For example, delaying an arrival time of a first vehicle 108 to a meet event or a pass event may result in a second vehicle 108 that previously was scheduled to participate in the event to pass by the first vehicle 108 before the first vehicle 108 encounters the siding section route 104 (shown in FIG. 1) to be used in the event. As a result, the vehicles 108 can avoid the movement event, and the first vehicle 108 can avoid slowing down or stopping on the siding section route 104, as described above.

At 1812, the modified schedules are communicated to the vehicles 108 (shown in FIG. 1). As described above, the modified schedules can be used by the control systems 114 (shown in FIG. 1) to change the trip plans of the vehicles 108. For example, the control systems 114 may create updated trip plans based on the delayed arrival time of one or more of the vehicles 108 at a movement event. Flow of the method 1800 may return to 106, where the trip plans are communicated to the scheduling system 118, as described above. The scheduling system 118 and control systems 114 may repeatedly generate schedules and trip plans and communicate the schedules and trip plans in a feedback loop between the scheduling system 118 and the control systems 114 in order to repeatedly update and/or modify one or more schedules and/or trip plans.

At 1814, a determination is made as to whether energy can be conserved and/or less emissions generated by one or more of the vehicles 108 (shown in FIG. 1) by modifying the schedules of the vehicles 108. For example, the scheduling system 118 (shown in FIG. 1) can determine if changing the schedules of one or more of the vehicles 108 to avoid a previously scheduled movement event can reduce the amount of fuel consumed by the vehicles 108 and/or reduce emissions that are generated by the vehicles 108. If the energy consumed by the vehicles 108 and/or emissions generated by the vehicles 108 can be reduced, then the schedules of the vehicles 108 may be modified to reduce the energy consumed and/or emissions generated. As a result, flow of the method 1800 proceeds to 1816. On the other hand, if the energy consumed by the vehicles 108 and/or emissions generated by the vehicles 108 cannot be reduced by changing the schedules, then the schedules of the vehicles 108 may not be modified. As a result, flow of the method 1800 proceeds to 1820.

At 1816, the schedules of one or more of the vehicles 108 (shown in FIG. 1) are modified. For example, the scheduling system 118 (shown in FIG. 1) may delay a scheduled time of a movement event for at least one of the vehicles 108 involved in the movement event, as described above. Delaying the time of the event may result in at least one of the vehicles 108 avoiding the event. Avoiding the movement event may also avoid one or more of the vehicles 108 having to slow down and/or stop for idling while waiting on a siding section route 104 (shown in FIG. 1) for another vehicle 108 to pass. The slowing down and/or idling can result in increased fuel consumption and/or emissions generated by the vehicles 108, such as during the acceleration of the vehicle 108 after slowing down and/or stopping and idling.

At 1818, the modified schedules are communicated to the vehicles 108 (shown in FIG. 1). As described above, the modified schedules can be used by the control systems 114 (shown in FIG. 1) to change the trip plans of the vehicles 108. For example, the control systems 114 may create updated trip plans based on the delayed arrival time of one or more of the vehicles 108 at a movement event. Flow of the method 1800 may return to 106, where the trip plans are communicated to the scheduling system 118 in a feedback loop, as described above.

At 1820, actual movement of the vehicles 108 (shown in FIG. 1) is tracked as the vehicles 108 move according to the schedules and/or trip plans. For example, the scheduling system 118 (shown in FIG. 1) may create schedules and use the trip plans made by the vehicles 108 based on the schedules as initial guides to where the vehicles 108 will be located at various times in the transportation network 100 (shown in FIG. 1). The scheduling system 118 can monitor actual movement of the vehicles 108 in the transportation network 100 to determine if one or more of the vehicles 108 deviate from associated schedules and/or trip plans, as described above.

At 1822, a determination is made as to whether the actual movements of the vehicles 108 (shown in FIG. 1) will or are likely to interfere with movement of one or more other vehicles 108. For example, the scheduling system 118 (shown in FIG. 1) may track movements of the vehicles 108 to determine if any factors or conditions of the vehicles 108 and/or routes 102 (shown in FIG. 1) cause or require the vehicles 108 to travel slower than the movement that is directed by the schedules and/or trip plans of the vehicles 108. Slower movement may result in interference with the travel of other vehicles 108, such as where a vehicle 108 will arrive too late to a movement event or otherwise may reduce the flow of travel in the transportation network 100.

If the actual movements of the vehicles 108 (shown in FIG. 1) will or are likely to interfere with movement of one or more other vehicles 108, then the trip plans of the vehicles 108 may need to be modified in order to avoid interfering with the other vehicles 108. As a result, flow of the method 1800 proceeds to 1824. On the other hand, if the actual movements of the vehicles 108 (shown in FIG. 1) will not or are not likely to interfere with movement of one or more other vehicles 108, then the trip plans of the vehicles 108 may not need to be modified in order to avoid interfering with the other vehicles 108. As a result, flow of the method 1800 returns to 1820, where continued movement of the vehicles 108 is monitored.

At 1824, the schedules of one or more of the vehicles 108 (shown in FIG. 1) are modified. For example, the scheduling system 118 (shown in FIG. 1) may delay a scheduled time of a movement event for at least one of the vehicles 108 involved in the movement event, as described above. Delaying the time of the event may result in at least one of the vehicles 108 avoiding the event, also as described above.

At 1826, the modified schedules are communicated to the vehicles 108 (shown in FIG. 1). As described above, the modified schedules can be used by the control systems 114 (shown in FIG. 1) to change the trip plans of the vehicles 108. Flow of the method 1800 may return to 106, where the trip plans are communicated to the scheduling system 118, as described above. The scheduling system 118 and control systems 114 may repeatedly generate schedules and trip plans and communicate the schedules and trip plans in a feedback loop between the scheduling system 118 and the control systems 114 in order to repeatedly update and/or modify one or more schedules and/or trip plans.

In another embodiment, a method is provided that includes forming a first schedule for a first vehicle to travel in a transportation network. The first schedule includes a first arrival time of the first vehicle at a scheduled location. The method also includes receiving a first trip plan for the first vehicle from an energy management system. The first trip plan is based on the first schedule and designates at least one of tractive efforts or braking efforts to be provided by the first vehicle to reduce at least one of an amount of energy consumed by the first vehicle or an amount of emissions generated by the first vehicle when the first vehicle travels through the transportation network to the scheduled location. The method further includes determining whether to modify the first schedule to avoid interfering with movement of one or more other vehicles by examining the trip plan for the first vehicle.

In another aspect, the method also includes modifying the first schedule into a different, modified second schedule based on the trip plan and communicating the modified second schedule to the first vehicle.

In another aspect, the method also includes receiving a different, modified second trip plan for the first vehicle that is based on the modified second schedule and determining whether to modify the modified second schedule based on the modified second trip plan.

In another aspect, the method also includes tracking actual movement of the first vehicle in the transportation network and modifying the first schedule of the first vehicle based on the actual movement.

In another aspect, the method also includes communicating the first schedule to the energy management system that is disposed on-board the first vehicle so that the energy management system can form the trip plan based on the first schedule.

In another aspect, the method also includes modifying the first schedule to avoid at least one of a meet event or a pass event between the first vehicle and one or more other vehicles.

In another aspect, the method also includes modifying the first schedule includes delaying a time that the first vehicle is to arrive at a siding section route for the at least one of the meet event or the pass event.

In another embodiment, a system is provided that includes a scheduling unit and a communication unit. The scheduling unit is configured to form a first schedule for a first vehicle to travel in a transportation network. The first schedule includes a first arrival time of the first vehicle at a scheduled location. The communication unit is configured to receive a first trip plan for the first vehicle from an energy management system. The first trip plan is based on the first schedule and designates at least one of tractive efforts or braking efforts to be provided by the first vehicle to reduce at least one of an amount of energy consumed by the first vehicle or an amount of emissions generated by the first vehicle when the first vehicle travels through the transportation network to the scheduled location. The scheduling unit also is configured to determine whether to modify the first schedule to avoid interfering with movement of one or more other vehicles by examining the trip plan for the first vehicle.

In another aspect, the scheduling unit is configured to modify the first schedule into a different, modified second schedule based on the trip plan and the communication unit is configured to communicate the modified second schedule to the first vehicle.

In another aspect, the communication unit is configured to receive a different, modified second trip plan for the first vehicle that is based on the modified second schedule and the scheduling unit is configured to determine whether to modify the modified second schedule based on the modified second trip plan.

In another aspect, the system also includes a tracking unit that is configured to monitor actual movement of the first vehicle in the transportation network, wherein the scheduling unit is configured to modify the first schedule of the first vehicle based on the actual movement.

In another aspect, the communication unit is configured to communicate the first schedule to the energy management system that is disposed on-board the first vehicle so that the energy management system can form the trip plan based on the first schedule.

In another aspect, the scheduling unit is configured to modify the first schedule to avoid at least one of a meet event or a pass event between the first vehicle and one or more other vehicles.

In another aspect, the scheduling unit is configured to modify the first schedule by delaying a time that the first vehicle is to arrive at a siding section route for the at least one of the meet event or the pass event.

In another embodiment, a method is provided that includes receiving a first schedule for a first vehicle to travel in a transportation network from a scheduling system. The first schedule includes a first arrival time of the first vehicle at a scheduled location. The method also includes forming a first trip plan for the first vehicle based on the first schedule. The trip plan designates at least one of tractive efforts or braking efforts to be provided by the first vehicle to reduce at least one of an amount of energy consumed by the first vehicle or an amount of emissions generated by the first vehicle when the first vehicle travels through the transportation network to the scheduled location. The method further includes communicating the first trip plan to the scheduling system so that the scheduling system can examine the first trip plan and determine whether to modify the first schedule based on the first trip plan.

In another aspect, the method also includes receiving a different, modified second schedule from the scheduling system that is based on the first trip plan and forming a different, modified second trip plan based on the modified second schedule.

In another aspect, the method also includes communicating the second trip plan to the scheduling system to enable the scheduling system to determine whether to modify the modified second schedule based on the modified second trip plan.

In another aspect, the method also includes reporting location information of the first vehicle to the scheduling system to permit the scheduling system to modify the first schedule of the first vehicle based on the location information.

In another embodiment, a system is provided that includes a communication unit and an energy management unit. The communication unit is configured to receive a first schedule for a first vehicle to travel in a transportation network from a scheduling system. The first schedule includes a first arrival time of the first vehicle at a scheduled location. The energy management unit is configured to form a first trip plan for the first vehicle based on the first schedule. The trip plan designates at least one of tractive efforts or braking efforts to be provided by the first vehicle to reduce at least one of an amount of energy consumed by the first vehicle or an amount of emissions generated by the first vehicle when the first vehicle travels through the transportation network to the scheduled location. The communication unit also is configured to communicate the first trip plan to the scheduling system so that the scheduling system can examine the first trip plan and determine whether to modify the first schedule based on the first trip plan.

In another aspect, the communication unit is configured to receive a different, modified second schedule from the scheduling system that is based on the first trip plan and the energy management unit is configured to form a different, modified second trip plan based on the modified second schedule.

In another aspect, the communication unit is configured to communicate the second trip plan to the scheduling system to enable the scheduling system to determine whether to modify the modified second schedule based on the modified second trip plan.

In another aspect, the system also includes a location determining device configured to determine location information of the first vehicle to permit the scheduling system to modify the first schedule of the first vehicle based on the location information.

Another embodiment relates to a method comprising, at plural vehicles in a transportation network, receiving plural respective first schedules from an off-board location. The method further comprises transmitting plural respective initial trip plans from the plural vehicles to the off-board location responsive to the plural respective first schedules, and receiving plural respective modified schedules at the plural vehicles from the off-board location responsive to the plural respective initial trip plans. The method may further comprise, at the vehicles, generating plural respective modified trip plans, for controlling the vehicles, based on the modified schedules.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter, including the best mode, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

What is claimed is:

1. A method comprising:
forming a first schedule for a first vehicle to travel in a transportation network, the first schedule including a first arrival time of the first vehicle at a scheduled location;
receiving a first trip plan for the first vehicle from an energy management system, the first trip plan based on the first schedule and designating at least one of tractive efforts or braking efforts to be provided by the first vehicle to reduce at least one of an amount of energy consumed by the first vehicle or an amount of emissions generated by the first vehicle when the first vehicle travels through the transportation network to the scheduled location; and
determining whether to modify the first schedule to avoid interfering with movement of one or more other vehicles by examining the trip plan for the first vehicle.

2. The method of claim 1, further comprising modifying the first schedule into a different, modified second schedule based on the trip plan and communicating the modified second schedule to the first vehicle.

3. The method of claim 2, further comprising receiving a different, modified second trip plan for the first vehicle that is based on the modified second schedule and determining whether to modify the modified second schedule based on the modified second trip plan.

4. The method of claim 1, further comprising tracking actual movement of the first vehicle in the transportation network and modifying the first schedule of the first vehicle based on the actual movement.

5. The method of claim 1, further comprising communicating the first schedule to the energy management system that is disposed on-board the first vehicle so that the energy management system can form the trip plan based on the first schedule.

6. The method of claim 1, further comprising modifying the first schedule to avoid at least one of a meet event or a pass event between the first vehicle and one or more other vehicles.

7. The method of claim 6, wherein modifying the first schedule includes delaying a time that the first vehicle is to arrive at a siding section route for the at least one of the meet event or the pass event.

8. A method comprising:
transmitting plural respective first schedules to plural vehicles in a transportation network;
receiving plural respective initial trip plans from the plural vehicles responsive to the first schedules; and
transmitting plural respective modified schedules of the first schedules to the vehicles, for the vehicles to generate modified trip plans for controlling the vehicles, if control of the vehicles according to the initial trip plans would result in interference with vehicle movement in the transportation network.

9. A system comprising:
a scheduling unit configured to form a first schedule for a first vehicle to travel in a transportation network, the first schedule including a first arrival time of the first vehicle at a scheduled location; and
a communication unit configured to receive a first trip plan for the first vehicle from an energy management system, the first trip plan based on the first schedule and designating at least one of tractive efforts or braking efforts to be provided by the first vehicle to reduce at least one of an amount of energy consumed by the first vehicle or an amount of emissions generated by the first vehicle when the first vehicle travels through the transportation network to the scheduled location;
wherein the scheduling unit is configured to determine whether to modify the first schedule to avoid interfering with movement of one or more other vehicles by examining the trip plan for the first vehicle.

10. The system of claim 9, wherein the scheduling unit is configured to modify the first schedule into a different, modified second schedule based on the trip plan and the communication unit is configured to communicate the modified second schedule to the first vehicle.

11. The system of claim 10, wherein the communication unit is configured to receive a different, modified second trip plan for the first vehicle that is based on the modified second schedule and the scheduling unit is configured to determine whether to modify the modified second schedule based on the modified second trip plan.

12. The system of claim 9, further comprising a tracking unit configured to monitor actual movement of the first vehicle in the transportation network, wherein the scheduling unit is configured to modify the first schedule of the first vehicle based on the actual movement.

13. The system of claim 9, wherein the communication unit is configured to communicate the first schedule to the energy management system that is disposed on-board the first vehicle so that the energy management system can form the trip plan based on the first schedule.

14. The system of claim 9, wherein the scheduling unit is configured to modify the first schedule to avoid at least one of a meet event or a pass event between the first vehicle and one or more other vehicles.

15. The system of claim 14, wherein the scheduling unit is configured to modify the first schedule by delaying a time that the first vehicle is to arrive at a siding section route for the at least one of the meet event or the pass event.

16. A method comprising:
receiving a first schedule for a first vehicle to travel in a transportation network from a scheduling system, the first schedule including a first arrival time of the first vehicle at a scheduled location;
forming a first trip plan for the first vehicle based on the first schedule, the trip plan designating at least one of tractive efforts or braking efforts to be provided by the first vehicle to reduce at least one of an amount of energy consumed by the first vehicle or an amount of emissions generated by the first vehicle when the first vehicle travels through the transportation network to the scheduled location; and
communicating the first trip plan to the scheduling system so that the scheduling system can examine the first trip plan and determine whether to modify the first schedule based on the first trip plan.

17. The method of claim 16, further comprising receiving a different, modified second schedule from the scheduling system that is based on the first trip plan and forming a different, modified second trip plan based on the modified second schedule.

18. The method of claim 17, further comprising communicating the second trip plan to the scheduling system to enable the scheduling system to determine whether to modify the modified second schedule based on the modified second trip plan.

19. The method of claim 16, further comprising reporting location information of the first vehicle to the scheduling system to permit the scheduling system to modify the first schedule of the first vehicle based on the location information.

20. A system comprising:
a communication unit configured to receive a first schedule for a first vehicle to travel in a transportation network from a scheduling system, the first schedule including a first arrival time of the first vehicle at a scheduled location; and
an energy management unit configured to form a first trip plan for the first vehicle based on the first schedule, the trip plan designating at least one of tractive efforts or braking efforts to be provided by the first vehicle to reduce at least one of an amount of energy consumed by the first vehicle or an amount of emissions generated by the first vehicle when the first vehicle travels through the transportation network to the scheduled location;
wherein the communication unit is configured to communicate the first trip plan to the scheduling system so that the scheduling system can examine the first trip plan and determine whether to modify the first schedule based on the first trip plan.

21. The system of claim 20, wherein the communication unit is configured to receive a different, modified second schedule from the scheduling system that is based on the first trip plan and the energy management unit is configured to form a different, modified second trip plan based on the modified second schedule.

22. The system of claim 20, wherein the communication unit is configured to communicate the second trip plan to the scheduling system to enable the scheduling system to determine whether to modify the modified second schedule based on the modified second trip plan.

23. The system of claim 20, further comprising a location determining device configured to determine location information of the first vehicle to permit the scheduling system to modify the first schedule of the first vehicle based on the location information.
